(19) United States
(12) Patent Application Publication
(10) Pub. No.: US 2013/0202048 A1
(43) Pub. Date: Aug. 8, 2013

(54) DEBLOCKING FILTERING APPARATUS AND METHOD BASED ON RASTER SCANNING

(71) Applicants: Doo Hyun KIM, Seoul (KR); Donggyu Sim, Seoul (KR); Do Hyung Kim, Hwaseong-si (KR); Joon Ho Song, Hwaseong-si (KR); Eun Kyung Ryu, Seoul (KR); Shi Hwa Lee, Seoul (KR); Hyun Ho Jo, Seoul (KR); Jeong Han Seo, Seoul (KR)

(72) Inventors: Doo Hyun KIM, Seoul (KR); Donggyu Sim, Seoul (KR); Do Hyung Kim, Hwaseong-si (KR); Joon Ho Song, Hwaseong-si (KR); Eun Kyung Ryu, Seoul (KR); Shi Hwa Lee, Seoul (KR); Hyun Ho Jo, Seoul (KR); Jeong Han Seo, Seoul (KR)

(73) Assignees: KWANGWOON UNIVERSITY INDUSTRY- ACADEMIC COLLABORATION FOUNDATION, Seoul (KR); SAMSUNG ELECTRONICS CO., LTD., Suwon (KR)

(21) Appl. No.: 13/596,349

(22) Filed: Aug. 28, 2012

(30) Foreign Application Priority Data
Feb. 6, 2012 (KR) 10-2012-0011597

(51) Int. Cl. H04N 7/26

(52) U.S. Cl. 375/240.24; 375/E07.189

(57) ABSTRACT

A deblocking filtering apparatus and method based on raster scanning is provided. The deblocking filtering apparatus may include a boundary determining unit to determine whether at least one of a vertical edge boundary and a horizontal edge boundary of a block corresponds to at least one of a coding unit (CU) boundary, a transform unit (TU) boundary, and a prediction unit (PU) boundary, a boundary strength (BS) computing unit to compute a BS value for at least one of the vertical edge boundary and the horizontal edge boundary when at least one of the vertical edge boundary and the horizontal edge boundary of the block corresponds to at least one of the CU boundary, the TU boundary, and the PU boundary as a result of the determining, and a filtering performing unit to perform deblocking filtering on at least one of the vertical edge boundary and the horizontal edge boundary.

### CROSS-REFERENCE TO RELATED APPLICATIONS

This application claims the priority benefit of Korean Patent Application No. 10-2012-0011597, filed on Feb. 6, 2012, in the Korean Intellectual Property Office, the disclosure of which is incorporated herein by reference.

### BACKGROUND

1. Field

Example embodiments relate to a technology for performing filtering in an order of raster scanning based on an 8×8 block unit within a largest coding unit (LCU) when a High Efficiency Video Coding (HEVC) video encoder and decoder performs deblocking filtering.

2. Description of the Related Art

High Efficiency Video Coding (HEVC) refers to a next generation video codec that is currently being standardized by the Joint Collaborative Team on Video Coding (JCT-VC), consisting of experts from Moving Picture Experts Group (MPEG) and Video Coding Experts Group (VCEG).

In contrast with video codecs such as H.264/AVC and prior codecs, HEVC may not perform coding in macroblock units. That is, HEVC replaces macroblocks with a flexible scheme based on coding units (CUs), which are variable size structures that sub-partition the picture into rectangular regions. Each CU contains variable-block-sized prediction unit (PUs) of either intra-picture or inter-picture prediction type, and transform units (TUs) which contain coefficients for spatial block transform and quantization. Thus, HEVC defines a CU, a TU, a PU, and the like, and uses the CU as a basic coding unit. This is done in order to resolve a problem occurring in conventional coding that is performed in macroblock units in which images of various resolutions are not taken into consideration due to a fixed size of the macroblock.

An HEVC encoder and decoder may perform encoding and decoding after dividing a macroblock into CUs using a largest coding unit (LCU) such as a quad tree structure.

A CU of a largest size, among the CUs, may be referred to as an LCU. An input image may be divided into a plurality of LCUs, and encoding and decoding may be performed on the image in LCU units. Each of the plurality of LCUs may be divided into a plurality of CUs based on a quad tree structure, and encoding and decoding may be performed on each of the plurality of LCUs. In such a quad tree structure-based coding process, CUs may be encoded or decoded based on a Z-order. Generally, a recursive function may be used to configure a Z-order based process to be software. A recursive structure may make it difficult to design hardware and to optimize software.

That is, the HEVC encoder and decoder may recursively perform deblocking filtering based on a CU unit, due to the quad tree structure based encoding and decoding scheme. The recursive execution may complicate hardware design, particularly, in a case of hardware-based design, and may cause degradation in system performance in a case of software-based operation.

### SUMMARY

The foregoing and/or other aspects are achieved by providing a deblocking filtering apparatus based on raster scanning, the apparatus including a boundary determining unit to determine whether at least one of a vertical edge boundary and a horizontal edge boundary of a block corresponds to at least one of a coding unit (CU) boundary, a transform unit (TU) boundary, and a prediction unit (PU) boundary, a boundary strength (BS) computing unit to compute a BS value for at least one of the vertical edge boundary and the horizontal edge boundary when at least one of the vertical edge boundary and the horizontal edge boundary of the block corresponds to at least one of the CU boundary, the TU boundary, and the PU boundary as a result of the determining, and a filtering performing unit to perform deblocking filtering on at least one of the vertical edge boundary and the horizontal edge boundary, based on the computed BS value.

The foregoing and/or other aspects are achieved by providing a deblocking filtering method based on raster scanning, the method including determining whether at least one of a vertical edge boundary and a horizontal edge boundary of a block corresponds to at least one of a CU boundary, a TU boundary, and a PU boundary, computing a BS value for at least one of the vertical edge boundary and the horizontal edge boundary when at least one of the vertical edge boundary and the horizontal edge boundary of the block corresponds to at least one of the CU boundary, the TU boundary, and the PU boundary as a result of the determining, and performing deblocking filtering on at least one of the vertical edge boundary and the horizontal edge boundary, based on the computed BS value.

The foregoing and/or other aspects are achieved by providing a deblocking filtering method based on raster scanning. The method includes determining whether a boundary of a block corresponds to at least one of a coding unit (CU) boundary, a transform unit (TU) boundary, and a prediction unit (PU) boundary, computing, by way of a processor, a boundary strength (BS) value for the boundary of the block when the boundary of the block corresponds to at least one of the CU boundary, the TU boundary, and the PU boundary as a result of the determining, and performing deblocking filtering on an edge of the block based on the computed BS value.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects will become apparent and more readily appreciated from the following description of embodiments, taken in conjunction with the accompanying drawings of which:

FIG. 1 illustrates a High Efficiency Video Coding (HEVC) decoder including an in-loop post-processing filter according to example embodiments;

FIG. 2 illustrates a deblocking filtering apparatus based on raster scanning according to example embodiments;

FIG. 3 illustrates an operation of performing deblocking filtering in coding unit (CU) units based on a Z order according to example embodiments;

FIG. 4 illustrates an operation of performing deblocking filtering on a vertical edge boundary based on 8×8 block raster scanning according to example embodiments;

FIG. 5 illustrates an operation of performing deblocking filtering on a horizontal edge boundary based on 8×8 block raster scanning according to example embodiments;

FIG. 6A illustrates a deblocking filtering method based on raster scanning according to example embodiments;

FIG. 6B illustrates a boundary determining unit of a deblocking filtering apparatus based on raster scanning according to example embodiments;

FIG. 7 illustrates tables indicating an order of Z-scanning in a 64×64 sized LCU according to example embodiments;

FIG. 8 illustrates tables indicating an order of Z-scanning in a 32×32 sized LCU according to example embodiments;

FIG. 9 illustrates a configuration of a CU boundary determining unit to determine a CU boundary in 8×8 block units according to example embodiments;

FIG. 10 illustrates an operation of a CU boundary condition determining unit of FIG. 9 according to example embodiments;

FIG. 11 illustrates a configuration of a transform unit (TU) boundary determining unit to determine a TU boundary in 8×8 block units according to example embodiments;

FIG. 12 illustrates an operation of a TU boundary condition determining unit of FIG. 11 according to example embodiments;

FIG. 13 illustrates a configuration of a prediction unit (PU) boundary determining unit to determine a PU boundary in 8×8 block units according to example embodiments; and

FIG. 14 illustrates an operation of a PU boundary condition determining unit of FIG. 13 according to example embodiments.

### DETAILED DESCRIPTION

Reference will now be made in detail to embodiments, examples of which are illustrated in the accompanying drawings, wherein like reference numerals refer to the like elements throughout. Embodiments are described below to explain the present disclosure by referring to the figures.

When it is determined that a detailed description is related to a related known function or configuration which may make the purpose of the present disclosure unnecessarily ambiguous in the description, such detailed description will be omitted. Also, terminologies used herein are defined to appropriately describe the exemplary embodiments and thus may be changed depending on a user, the intent of an operator, or a custom. Accordingly, the terminologies must be defined based on the following overall description of this specification.

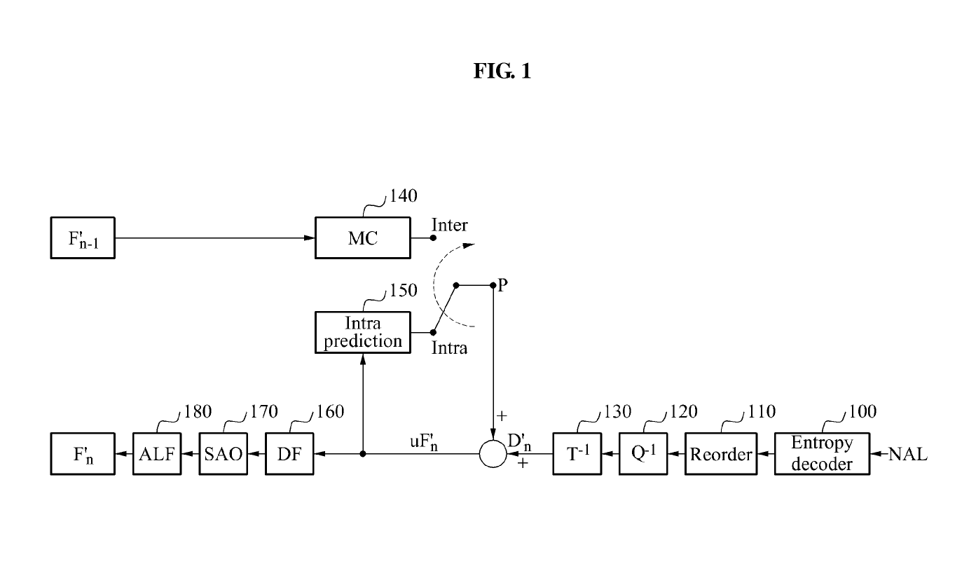

FIG. 1 illustrates a High Efficiency Video Coding (HEVC) decoder including an in-loop post-processing filter, for example, a deblocking filter, a sample adaptive offset (SAO), an adaptive loop filter (ALF), and the like, according to example embodiments.

That is, FIG. 1 is a block diagram illustrating a configuration of an HEVC video decoder according to example embodiments.

The example embodiments may include an apparatus and method that may eliminate a conventional recursive structure by processing a deblocking filter structure, generally processed in a Z order in coding unit (CU) units, in an order of raster scanning in 8×8 block units. The example embodiments may also include an apparatus and method that may perform deblocking filtering in a raster scanning order, by determining whether filtering is to be performed at a corresponding boundary, based on CU depth information, transform unit (TU) depth information, prediction unit (PU) division information, a size of a largest coding unit (LCU), an X-axial offset, a Y-axial offset, and the like, when deblocking filtering is applied to a vertical edge boundary and a horizontal edge boundary of an 8×8 block.

To achieve the foregoing, the HEVC video decoder of FIG. 1 may include, for example, an entropy decoding unit 100, a reordering unit 110, an inverse quantization unit 120, an inverse transform unit 130, a motion compensation unit 140, an intra prediction unit 150, a raster scanning based deblocking filtering unit 160, an SAO performing unit 170, and an ALF performing unit 180.

A coefficient value of a bitstream that is input to the HEVC video decoder may be entropy-decoded by the entropy decoding unit 100, and the decoded coefficient value may be reordered by the reordering unit 110. The reordered coefficient value may be inverse-quantized by the inverse quantization unit 120, inverse transformed by the inverse transform unit 130, and decoded to be a differential pixel value.

The decoded differential pixel value may be added to a prediction value generated by the motion compensation unit 140 or the intra prediction unit 150, and decoding may be performed on a resulting value in block units. Upon completion of the decoding performed on an input image in block units, the decoded image may be post-processing filtered through the deblocking filtering unit 160, the SAO performing unit 170, and the ALF performing unit 180, and the filtered image may be used in an intra prediction process for a subsequent image.

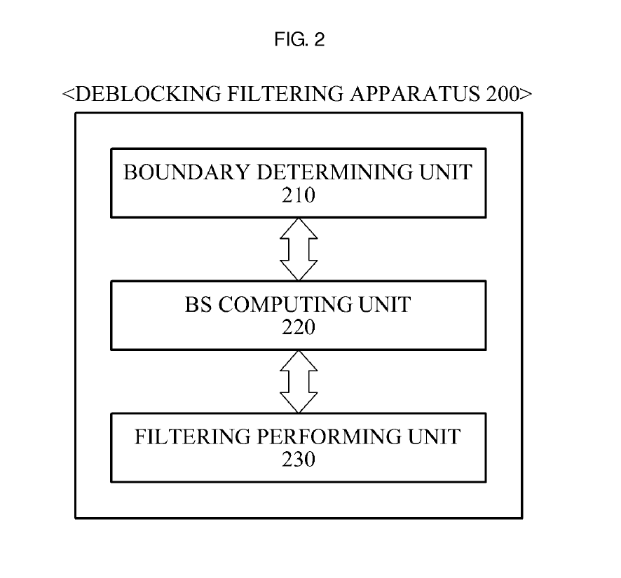

FIG. 2 illustrates a deblocking filtering apparatus 200 based on raster scanning according to example embodiments.

The deblocking filtering apparatus 200 may include a boundary determining unit 210, a boundary strength (BS) computing unit 220, and a filtering performing unit 230.

The boundary determining unit 210 may determine whether at least one of a vertical edge boundary and a horizontal edge boundary of a block corresponds to at least one of a CU boundary, a TU boundary, and a PU boundary.

When at least one of the vertical edge boundary and the horizontal edge boundary of the block corresponds to at least one of the CU boundary, the TU boundary, and the PU boundary as a result of the determining, the BS computing unit 220 may compute a BS value for at least one of the vertical edge boundary and the horizontal edge boundary.

The filtering performing unit 230 may perform deblocking filtering on at least one of the vertical edge boundary and the horizontal edge boundary, using the computed BS value.

In particular, the filtering performing unit 230 may perform deblocking filtering on the vertical edge boundary of the block, or may perform deblocking filtering on the horizontal edge boundary, or both, upon completion of the deblocking filtering performed on the vertical edge boundary of the block.

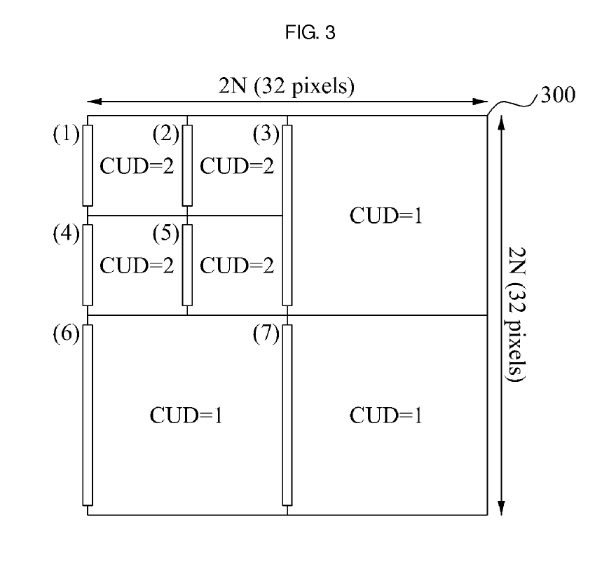

FIG. 3 illustrates an operation of performing deblocking filtering in CU units based on a Z order according to example embodiments.

That is, FIG. 3 is a diagram illustrating an operational sequence of a deblocking filtering unit based on Z-order scanning of an HEVC.

Referring to FIG. 3, when performing filtering on a vertical edge boundary, the deblocking filtering unit may perform filtering in an order of CUs (1) to (7), based on an extent of division of CUs of an LCU 300. The order of filtering may be based on Z-order scanning in CU division of a quad tree structure.

When performing the filtering on each of the CUs, the deblocking filtering unit may perform filtering on an 8×8 block, which is a minimum unit of filtering, based on division information of a PU and a TU of a corresponding CU. The deblocking filtering unit may perform deblocking filtering on a vertical edge boundary in the LCU 300, and may perform deblocking filtering on a horizontal edge boundary based on Z-order scanning.

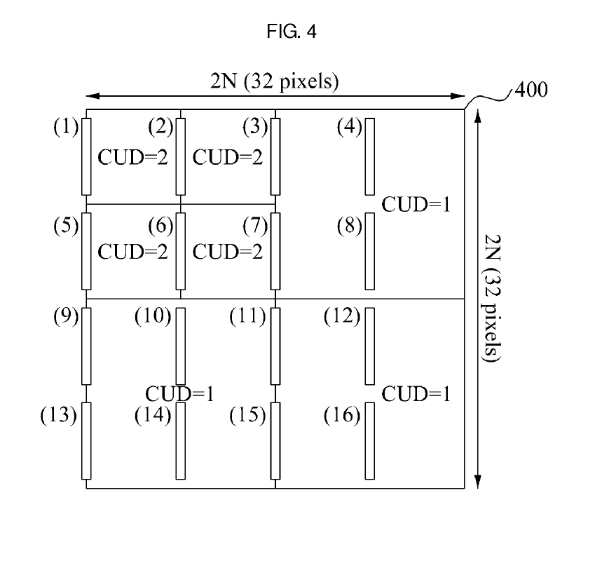

FIG. 4 illustrates an operation of performing deblocking filtering on a vertical edge boundary based on 8×8 block raster scanning according to example embodiments.

That is, FIG. 4 is a diagram illustrating an operational sequence of the deblocking filtering unit 160 of FIG. 1 according to example embodiments.

Referring to FIG. 4, the deblocking filtering unit 160 may perform filtering on a vertical edge boundary in an order of (1) to (16) based on an 8×8 block, which is a minimum unit of filtering, in an LCU 400.

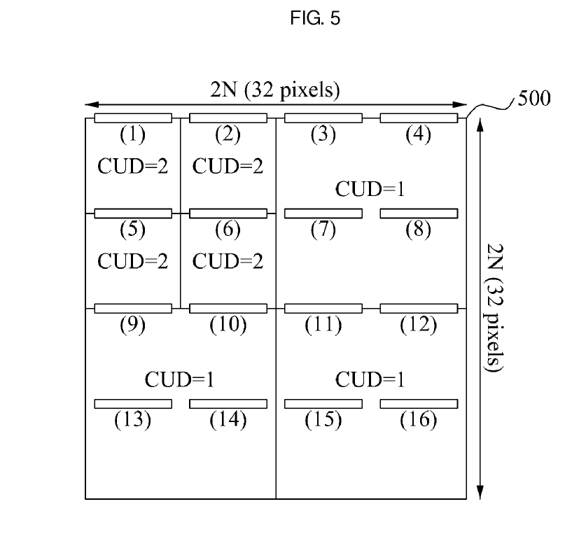

FIG. 5 illustrates an operation of performing deblocking filtering on a horizontal edge boundary based on 8×8 block raster scanning according to example embodiments.

That is, FIG. 5 is a diagram illustrating an operational sequence of the deblocking filtering unit 160 of FIG. 1 according to example embodiments.

Referring to FIG. 5, the deblocking filtering unit 160 may perform filtering on a vertical edge boundary of an LCU 500, and may perform filtering on a horizontal edge boundary in an order of CUs (1) to (16), based on an 8×8 block.

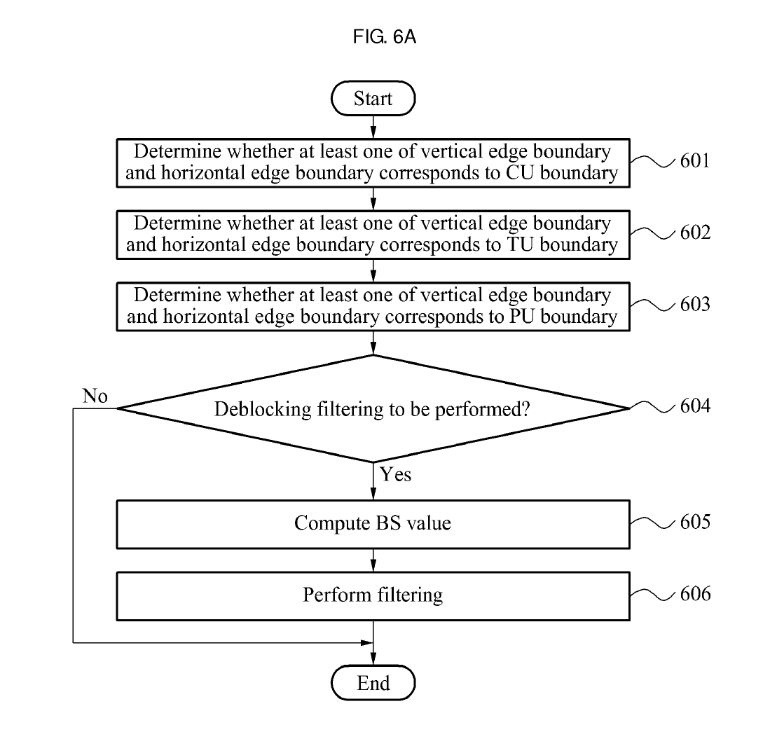

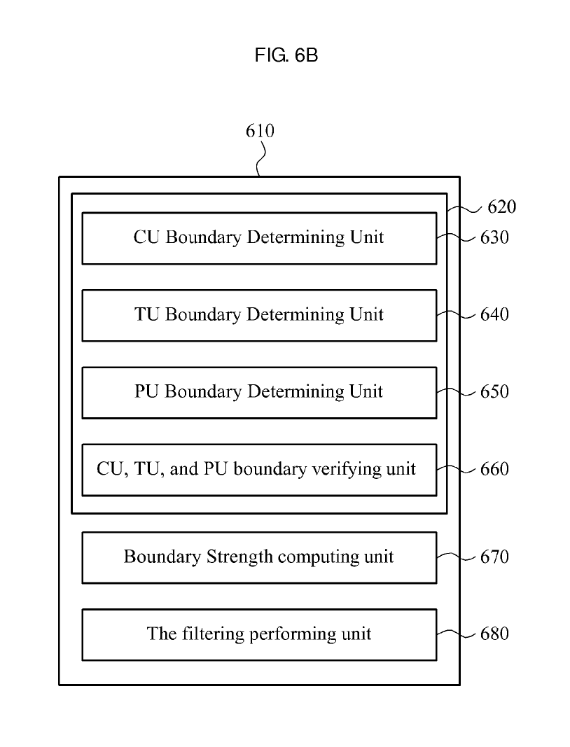

FIG. 6A illustrates a deblocking filtering method based on raster scanning according to example embodiments.

In the deblocking filtering method, whether at least one of a vertical edge boundary and a horizontal edge boundary of a block corresponds to a CU boundary may be determined in operation 601. Whether at least one of the vertical edge boundary and the horizontal edge boundary of the block corresponds to a TU boundary may be determined in operation 602. Whether at least one of the vertical edge boundary and the horizontal edge boundary of the block corresponds to a PU boundary may be determined in operation 603.

In operation 604, whether deblocking filtering is to be performed may be determined based on results of operations 601, 602, and 603.

When at least one of the vertical edge boundary and the horizontal edge boundary of the block corresponds to at least one of the CU boundary, the TU boundary, and the PU boundary, and the deblocking filtering is determined to be performed in operation 604, a BS value for at least one of the vertical edge boundary and the horizontal edge boundary may be computed in operation 605, and the deblocking filtering may be performed in operation 606, using the computed BS value.

When at least one of the vertical edge boundary and the horizontal edge boundary fails to correspond to at least one of the CU boundary, the TU boundary, and the PU boundary, and the deblocking filtering is determined not to be performed in operation 604, a process may be terminated without the deblocking filtering being performed.

FIG. 6B illustrates a boundary determining unit of a deblocking filtering apparatus based on raster scanning according to example embodiments.

Deblocking filtering apparatus 610 may include, for example, boundary determining unit 620, BS computing unit 670, and filtering performing unit 680. A boundary determining unit of a deblocking filtering apparatus based on raster scanning may perform deblocking filtering on an 8×8 block. The boundary determining unit 610 may include, for example, a CU boundary determining unit 630, a TU boundary determining unit 640, a PU boundary determining unit 650, and a CU, TU, and PU boundary verifying unit 660.

The CU boundary determining unit 630 may perform operation 601, the TU boundary determining unit 640 may perform operation 602, and the PU boundary determining unit 650 may perform operation 603, for example.

When filtering is to be performed on a vertical edge boundary of an 8×8 block, the CU boundary determining unit 630 may determine whether the vertical edge boundary of the 8×8 block is positioned at a CU boundary, based on CU depth information of a block positioned on a right side of the vertical edge boundary of the 8×8 block.

The TU boundary determining unit 640 may determine whether the vertical edge boundary of the 8×8 block is positioned at a TU boundary, based on the CU depth information and TU depth information of the block positioned on the right side of the vertical edge boundary of the 8×8 block.

The PU boundary determining unit 650 may determine whether the vertical edge boundary of the 8×8 block is positioned at a PU boundary, based on the CU depth information and PU division information of the block positioned on the right side of the vertical edge boundary of the 8×8 block.

The CU, TU, and PU 660 boundary verifying unit may verify whether the vertical edge boundary of the 8×8 block, on which deblocking filtering is to be performed, corresponds to one of the CU boundary, the TU boundary, and the PU boundary. When the vertical edge boundary of the 8×8 block is verified to be one of the CU boundary, the TU boundary, and the PU boundary, the BS computing unit 670 may compute a BS value for the vertical edge boundary of the 8×8 block, and the filtering performing unit 680 may perform filtering on the vertical edge boundary based on the computed BS value. Otherwise, when the vertical edge boundary of the 8×8 block does not correspond to any of the CU boundary, the TU boundary, and the PU boundary, a process of computing the BS value and a process of performing the deblocking filtering may not be applied to a corresponding edge boundary.

When filtering is to be performed on a horizontal boundary of the 8×8 block, the CU boundary determining unit 630 may determine whether the horizontal edge boundary of the 8×8 block is positioned at a CU boundary, based on CU depth information of a block positioned on a lower portion of the horizontal edge boundary of the 8×8 block.

The TU boundary determining unit 640 may determine whether the horizontal edge boundary of the 8×8 block is positioned at a TU boundary, based on the CU depth information and TU depth information of the block positioned on the lower portion of the horizontal edge boundary of the 8×8 block. The PU boundary determining unit 650 may determine whether the horizontal edge boundary of the 8×8 block is positioned at a PU boundary, based on the CU depth information and PU division information of the block positioned on the lower portion of the horizontal edge boundary of the 8×8 block.

The CU, TU, and PU boundary verifying unit 660 may verify whether the horizontal edge boundary of the 8×8 block, on which deblocking filtering is to be performed, corresponds to one of the CU boundary, the TU boundary, and the PU boundary. When the horizontal edge boundary of the 8×8 block is verified to be one of the CU boundary, the TU boundary, and the PU boundary, the BS computing unit 670 may compute a BS value for the horizontal edge boundary of the 8×8 block, and the filtering performing unit 680 may perform filtering on the horizontal edge boundary based on the computed BS value. When the horizontal edge boundary of the 8×8 block fails to correspond to any of the CU boundary, the TU boundary, and the PU boundary, a process of computing the BS value and a process of performing the deblocking filtering may not be applied to a corresponding edge boundary.

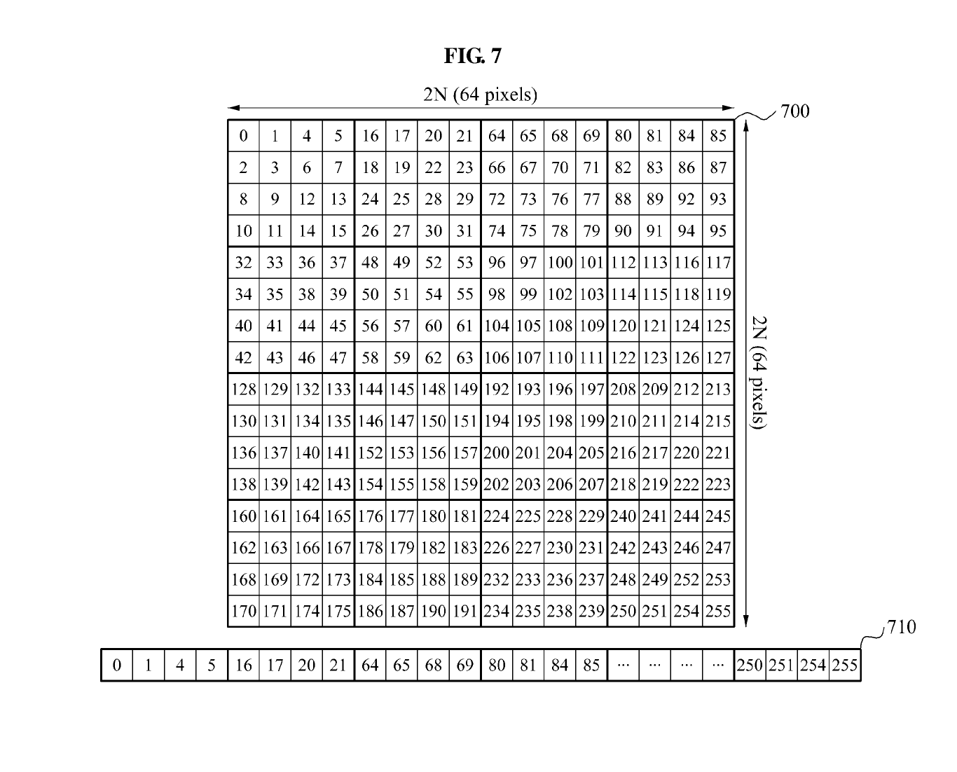

FIG. 7 illustrates tables indicating an order of Z-scanning in a 64×64 sized LCU according to example embodiments.

That is, FIG. 7 is a diagram illustrating configurations of a Z order in a 64×64 sized LCU according to example embodiments.

Referring to FIG. 7, when a CU boundary determining unit, a TU boundary determining unit, and a PU boundary determining unit refer to encoding and decoding parameters of a block stored in a Z order, the CU boundary determining unit, the TU boundary determining unit, and the PU boundary determining unit may refer to a Z-order table 700, which is predefined in 4×4 block units based on a size of an input LCU. When a Z-order table is configured in a two-dimensional format, a corresponding value may be obtained through an x-axial block offset and a y-axial block offset. Also, the Z-order table may be configured in a one-dimensional format, similar to a table 710.

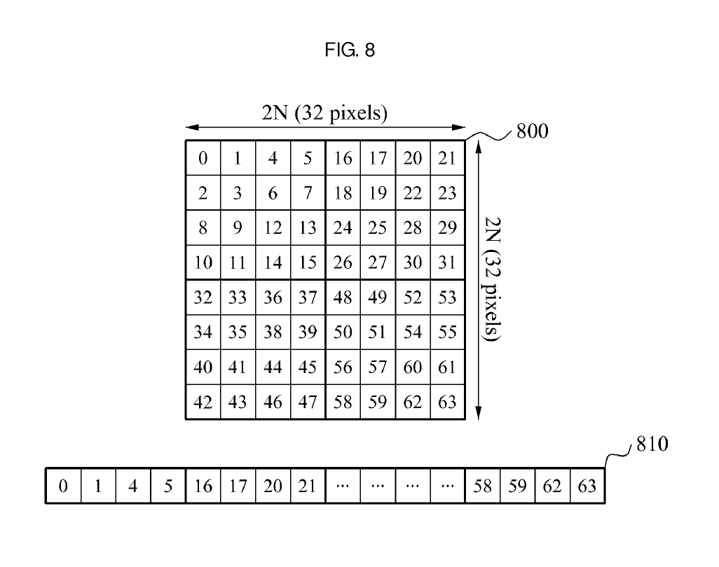

FIG. 8 illustrates tables indicating an order of Z-scanning in a 32×32 sized LCU according to example embodiments.

That is, FIG. 8 is a diagram illustrating configurations of a Z-order in a 32×32 sized LCU according to example embodiments.

Referring to FIG. 8, when a CU boundary determining unit, a TU boundary determining unit, and a PU boundary determining unit refer to encoding and decoding parameters of a block stored in a Z order, the CU boundary determining unit, the TU boundary determining unit, and the PU boundary determining unit may refer to a Z-order table 800, which is predefined in 4'4 block units based on a size of an input LCU. When a Z-order table is configured in a two-dimensional format, a corresponding value may be obtained through an x-axial block offset and a y-axial block offset. Also, the Z-order table may be configured in a one-dimensional format, similar to a table 810.

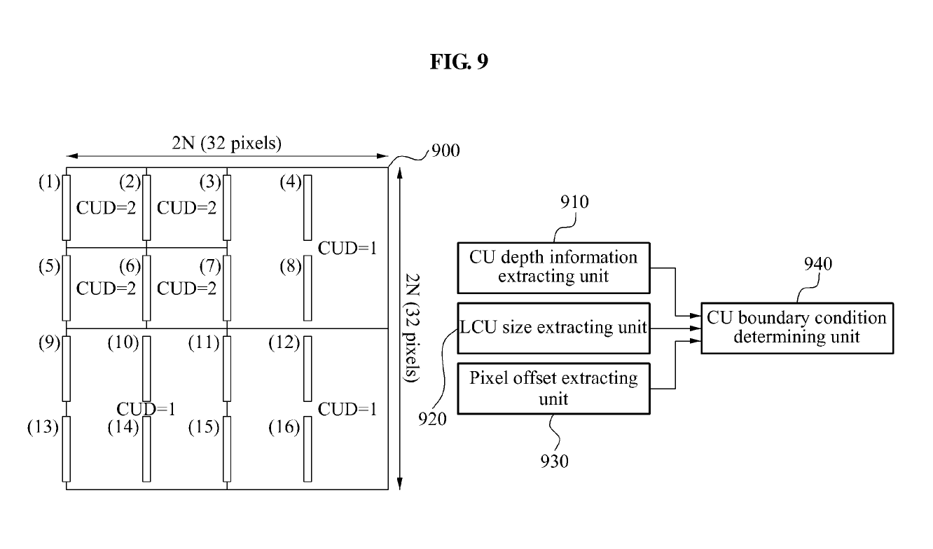

FIG. 9 illustrates a configuration of a CU boundary determining unit to determine a CU boundary in 8×8 block units according to example embodiments.

That is, FIG. 9 is a diagram illustrating a configuration of a CU boundary determining unit according to example embodiments.

Referring to FIG. 9, the CU boundary determining unit may determine whether a vertical edge boundary and a horizontal edge boundary of each 8×8 block are positioned at a CU boundary, sequentially, in an order of (1) to (16) with respect to each 8×8 block of an input LCU 900. The CU boundary determining unit may include a CU depth information extracting unit 910, an LCU size extracting unit 920, a pixel offset extracting unit 930, and a CU boundary condition determining unit 940.

When deblocking filtering is to be performed on the vertical edge boundary, the CU depth information extracting unit 910 may extract CU depth information of a block positioned on a right side of a left vertical edge boundary of each 8×8 block. For example, the CU depth information extracting unit 910 may extract CU depth information of a level 2 from a block positioned on a right side of a left vertical edge boundary (1) of a first 8×8 block of FIG. 9. The LCU size extracting unit 920 may extract a size of an LCU including the block positioned on the right side of the left vertical edge boundary of each 8×8 block. The pixel offset extracting unit 930 may extract an X-axial offset within the LCU with respect to the left vertical edge boundary of each 8×8 block. For example, a value of an X-axial offset at a left vertical edge boundary (2) of a second 8×8 block of FIG. 9 may correspond to a value of 8. The CU boundary condition determining unit 940 may determine whether the left vertical edge boundary of each 8×8 block is positioned at a CU boundary, based on the CU depth information extracted by the CU depth information extracting unit 910, the LCU size extracted by the LCU size extracting unit 920, and the X-axial offset extracted by the pixel offset extracting unit 930.

When deblocking filtering is to be performed on the horizontal edge boundary, the CU depth information extracting unit 910 may extract CU depth information of a block positioned on a lower portion of an upper horizontal edge boundary of each 8×8 block. The LCU size extracting unit 920 may extract a size of an LCU including the block positioned on the lower portion of the upper horizontal edge boundary of each 8×8 block. The pixel offset extracting unit 930 may extract a Y-axial offset within the LCU with respect to the upper horizontal edge boundary of each 8×8 block. The CU boundary condition determining unit 940 may determine whether the upper horizontal edge boundary of each 8×8 block is positioned at a CU boundary, based on the CU depth information extracted by the CU depth information extracting unit 910, the LCU size extracted by the LCU size extracting unit 920, and the Y-axial offset extracted by the pixel offset extracting unit 930.

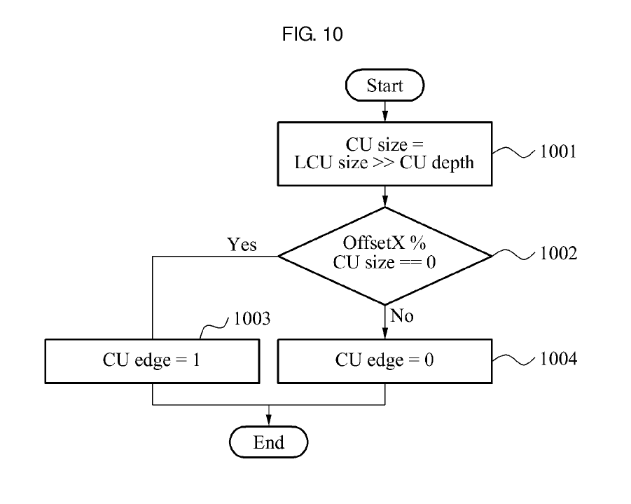

FIG. 10 illustrates an operation of the CU boundary condition determining unit 940 of FIG. 9 according to example embodiments.

That is, FIG. 10 is a flowchart illustrating an operational sequence of the CU boundary condition determining unit 940 of FIG. 9 according to example embodiments.

Referring to FIG. 10, the CU boundary condition determining unit 940 may compute a size of a CU block, based on a size of an input LCU and CU depth information, in operation 1001.

When deblocking filtering is to be performed on a vertical edge boundary, the CU boundary condition determining unit 940 may determine whether a resulting value obtained by performing a modulo operation of ‘OffsetX mod CU size’ corresponds to a value of 0, in operation 1002. Here, OffsetX denotes an X-axial offset extracted by a pixel offset extracting unit, and CU size denotes a size of a CU block.

When the resulting value corresponds to a value of 0, the CU boundary condition determining unit 940 may determine a left vertical edge boundary of a corresponding 8×8 block to be a CU boundary, in operation 1003. Otherwise, the CU boundary condition determining unit 940 may determine the left vertical edge boundary of the corresponding 8×8 block to not be the CU boundary, in operation 1004.

The modulo operation of the determining process may be replaced with an “& bit operation.”

When deblocking filtering is to be performed on a horizontal edge boundary, the CU boundary condition determining unit 940 may determine whether a resulting value obtained by performing a modulo operation of ‘OffsetY mod CU size’ corresponds to value of 0, in operation 1002. Here, OffsetY denotes a Y-axial offset extracted by the pixel offset extracting unit, and CU size denotes a size of a CU block.

When the resulting value corresponds to a value of 0, the CU boundary condition determining unit 940 may determine an upper horizontal edge boundary of a corresponding 8×8 block to be a CU boundary, in operation 1003. Otherwise, the CU boundary condition determining unit 940 may determine the upper horizontal edge boundary of the corresponding 8×8 block to not be the CU boundary, in operation 1004.

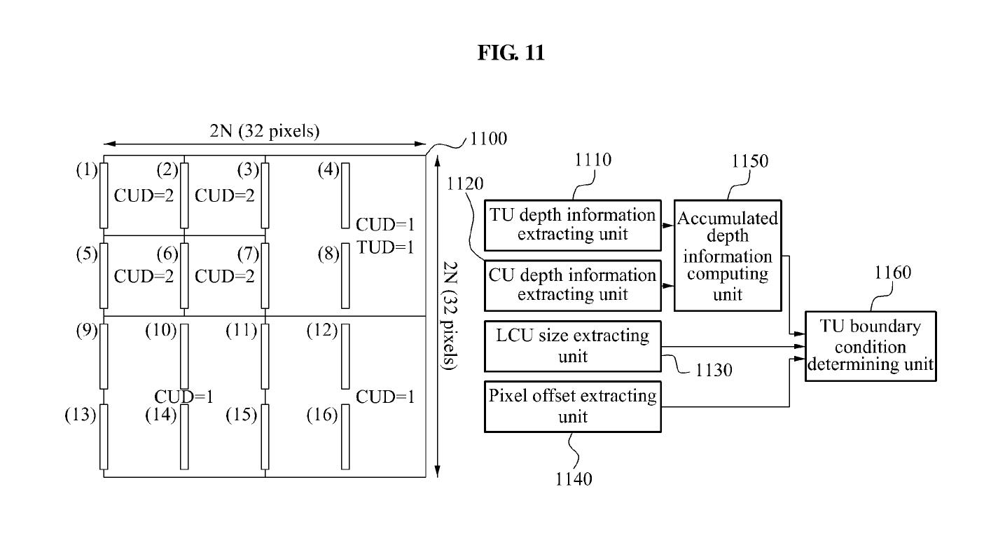

FIG. 11 illustrates a configuration of a TU boundary determining unit to determine a TU boundary in 8×8 block units according to example embodiments.

That is, FIG. 11 is a diagram illustrating a configuration of a TU boundary determining unit according to example embodiments.

Referring to FIG. 11, the TU boundary determining unit may determine whether a vertical edge boundary and a horizontal edge boundary of each 8×8 block are positioned at a TU boundary, sequentially, in an order of (1) to (16) with respect to each 8×8 block of an input LCU 1100.

The TU boundary determining unit may include, for example, a TU depth information extracting unit 1110, a CU depth extracting unit 1120, an LCU size extracting unit 1130, a pixel offset extracting unit 1140, an accumulated depth information computing unit 1150, and a TU boundary condition determining unit 1160.

When deblocking filtering is to be performed on the vertical edge boundary, the TU depth information extracting unit 1110 may extract TU depth information of a block positioned on a right side of a left vertical edge boundary of each 8×8 block. For example, the TU depth information extracting unit 1110 may extract TU depth information of a level 1 at positions corresponding to (3), (4), (7), and (8) of FIG. 11.

The CU depth information extracting unit 1120 may extract CU depth information of the block positioned on the right side of the left vertical edge boundary of each 8×8 block.

The LCU size extracting unit 1130 may extract a size of an LCU including the block positioned on the right side of the left vertical edge boundary of each 8×8 block.

The pixel offset extracting unit 1140 may extract an X-axial offset within the LCU with respect to the left vertical edge boundary of each 8×8 block.

The accumulated depth information computing unit 1150 may compute accumulated depth information by adding the TU depth information extracted by the TU depth information extracting unit 1110 and the CU depth information extracted by the CU depth information extracting unit 1120. The TU boundary condition determining unit 1160 may determine whether the left vertical edge boundary of each 8×8 block is positioned at a TU boundary, based on the accumulated depth information computed by the accumulated depth information computing unit 1150, the LCU size extracted by the LCU size extracting unit 1130, and the X-axial offset extracted by the pixel offset extracting unit 1140.

When deblocking filtering is to be performed on the horizontal edge boundary, the TU depth information extracting unit 1110 may extract TU depth information of a block positioned on a lower portion of an upper horizontal edge boundary of each 8×8 block. The CU depth information extracting unit 1120 may extract CU depth information of the block positioned on the lower portion of the upper horizontal edge boundary of each 8×8 block. The LCU size extracting unit 1130 may extract a size of an LCU including the block positioned on the lower portion of the upper horizontal edge boundary of each 8×8 block. The pixel offset extracting unit 1140 may extract a Y-axial offset within the LCU with respect to the upper horizontal edge boundary of each 8×8 block. The accumulated depth information computing unit 1150 may compute accumulated depth information by adding the TU depth information extracted by the TU depth information extracting unit 1110 and the CU depth information extracted by the CU depth information extracting unit 1120. The TU boundary condition determining unit 1160 may determine whether the upper horizontal edge boundary of each 8×8 block is positioned at a TU boundary, based on the accumulated depth information computed by the accumulated depth information computing unit 1150, the LCU size extracted by the LCU size extracting unit 1130, and the Y-axial offset extracted by the pixel offset extracting unit 1140.

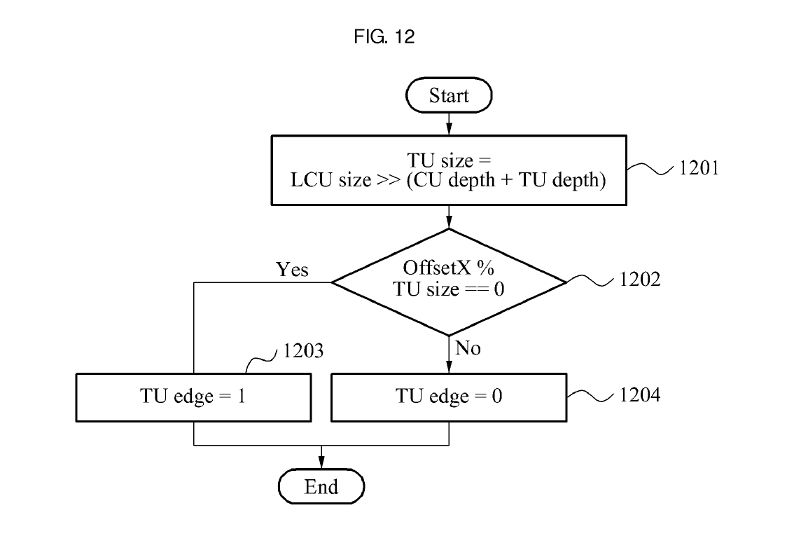

FIG. 12 illustrates an operation of the TU boundary condition determining unit 1160 of FIG. 11 according to example embodiments.

That is, FIG. 12 is a flowchart illustrating an operational sequence of the TU boundary condition determining unit 1160 of FIG. 11 according to example embodiments.

Referring to FIG. 12, the TU boundary condition determining unit 1160 (FIG. 11) may compute a size of a TU block based on accumulated depth information obtained by adding a size of an input LCU, CU depth information, and TU depth information, in operation 1201. When deblocking filtering is to be performed on a vertical edge boundary, the TU boundary condition determining unit 1160 may determine whether a resulting value obtained by performing a modulo operation of ‘OffsetX mod TU size’ corresponds to a value of 0, in operation 1202. Here, OffsetX denotes an X-axial offset extracted by a pixel offset extracting unit, and TU size denotes a size of a TU block.

When the resulting value corresponds to a value of 0, the TU boundary condition determining unit 1160 may determine a left vertical edge boundary of a corresponding 8×8 block to be a TU boundary, in operation 1203. Otherwise, the TU boundary condition determining unit 1160 may determine the left vertical edge boundary of the corresponding 8×8 block to not be the TU boundary, in operation 1204.

The modulo operation of the determining process may be replaced with an “& bit operation.”

When deblocking filtering is to be performed on a horizontal edge boundary, the TU boundary condition determining unit 1160 may determine whether a resulting value obtained by performing a modulo operation of ‘OffsetY mod TU size’ corresponds to a value of 0, in operation 1202. Here, OffsetY denotes a Y-axial offset extracted by the pixel offset extracting unit, and TU size denotes a size of a TU block.

When the resulting value corresponds to a value of 0, the TU boundary condition determining unit 1160 may determine an upper horizontal edge boundary of a corresponding 8×8 block to be a TU boundary, in operation 1203. Otherwise, the TU boundary condition determining unit may determine the upper horizontal edge boundary of the corresponding 8×8 block to not be the TU boundary, in operation 1204.

The modulo operation of the determining process may be replaced with an “& bit operation.”

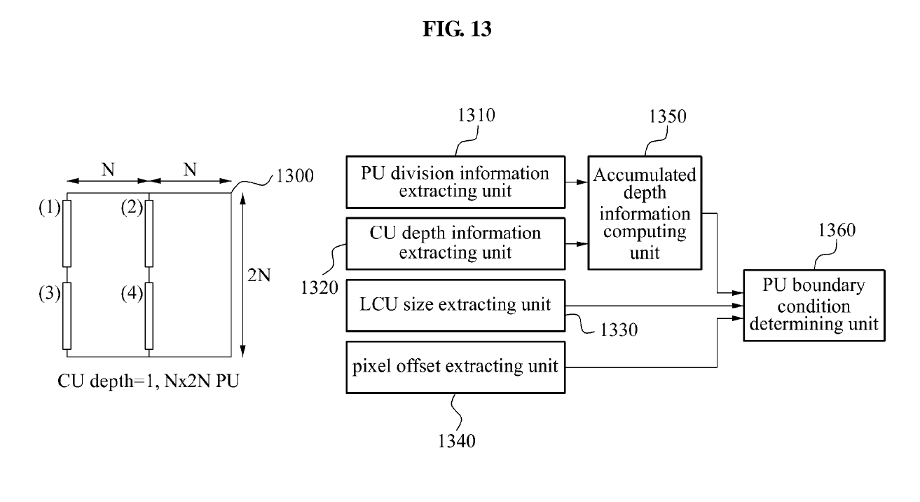

FIG. 13 illustrates a configuration of a PU boundary determining unit to determine a PU boundary in 8×8 block units according to example embodiments.

That is, FIG. 13 is a diagram illustrating a configuration of a PU boundary determining unit according to example embodiments.

Referring to FIG. 13, the PU boundary determining unit may determine whether a vertical edge boundary and a horizontal edge boundary of each 8×8 block are positioned at a PU boundary, sequentially, in an order of (1) to (16) with respect to each 8×8 block of an input LCU 1300.

The PU boundary determining unit may include, for example, a PU division information extracting unit 1310, a CU depth extracting unit 1320, an LCU size extracting unit 1330, a pixel offset extracting unit 1340, an accumulated depth information computing unit 1350, and a PU boundary condition determining unit 1360.

When deblocking filtering is to be performed on the vertical edge boundary, the PU division information extracting unit 1310 may extract PU division information of a block positioned on a right side of a left vertical edge boundary of each 8×8 block.

For example, when a 2N×2N LCU 1300 is divided into two N×2N PUs, the PU division information extracting unit 1310 may extract division information of N×2N at positions corresponding to (1), (2), (3), and (4) of FIG. 13.

The CU depth information extracting unit 1320 may extract CU depth information of the block positioned on the right side of the left vertical edge boundary of each 8×8 block.

The LCU size extracting unit 1330 may extract a size of an LCU including the block positioned on the right side of the left vertical edge boundary of each 8×8 block.

The pixel offset extracting unit 1340 may extract an X-axial offset within the LCU with respect to the left vertical edge boundary of each 8×8 block.

The accumulated depth information computing unit 1350 may compute accumulated depth information by adding the PU division information extracted by the PU division information extracting unit 1310 and the CU depth information extracted by the CU depth information extracting unit 1320.

The PU boundary condition determining unit 1360 may determine whether the left vertical edge boundary of each 8×8 block is positioned at a PU boundary, based on the accumulated depth information computed by the accumulated depth information computing unit 1350, the LCU size extracted by the LCU size extracting unit 1330, and the X-axial offset extracted by the pixel offset extracting unit 1340.

When deblocking filtering is to be performed on the horizontal edge boundary, the PU division information extracting unit 1310 may extract PU division information of a block positioned on a lower portion of an upper horizontal edge boundary of each 8×8 block.

The CU depth information extracting unit 1320 may extract CU depth information of the block positioned on the lower portion of the upper horizontal edge boundary of each 8×8 block.

The LCU size extracting unit 1330 may extract a size of an LCU including the block positioned on the lower portion of the upper horizontal edge boundary of each 8×8 block.

The pixel offset extracting unit 1340 may extract a Y-axial offset within the LCU with respect to the upper horizontal edge boundary of each 8×8 block.

The accumulated depth information computing unit 1350 may compute accumulated depth information by adding the PU division information extracted by the PU division information extracting unit 1310 and the CU depth information extracted by the CU depth information extracting unit 1320.

The PU boundary condition determining unit 1360 may determine whether the upper horizontal edge boundary of each 8×8 block is positioned at a PU boundary, based on the accumulated depth information computed by the accumulated depth information computing unit 1350, the LCU size extracted by the LCU size extracting unit 1330, and the Y-axial offset extracted by the pixel offset extracting unit 1340.

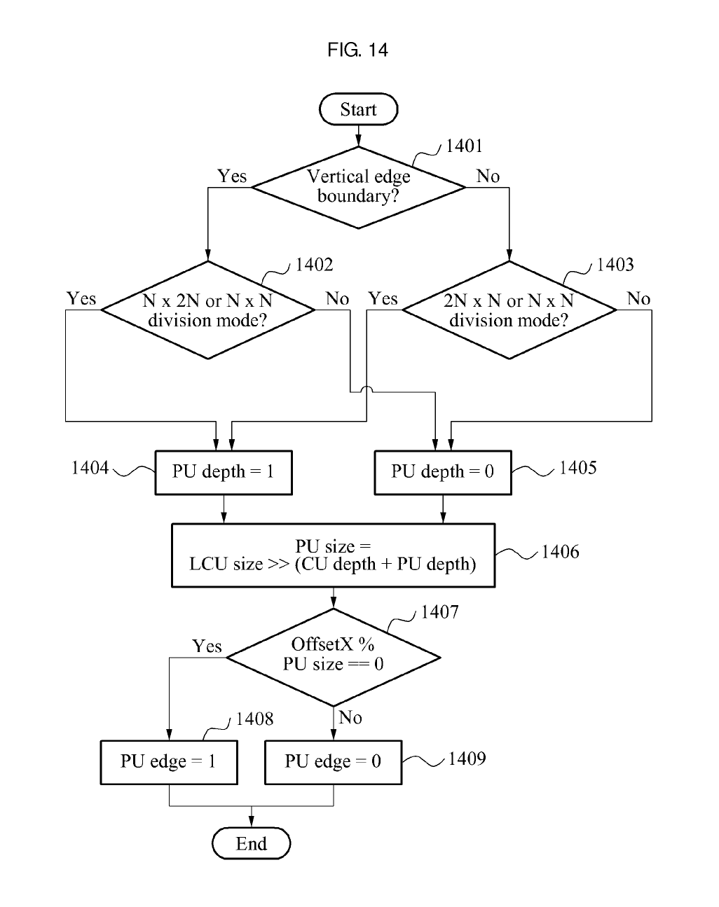

FIG. 14 illustrates an operation of the PU boundary condition determining unit 1360 of FIG. 13 according to example embodiments.

That is, FIG. 14 is a flowchart illustrating an operational sequence of the PU boundary condition determining unit 1360 of FIG. 13 according to example embodiments.

Referring to FIG. 14, the PU boundary condition determining unit 1360 may determine whether an edge boundary on which deblocking filtering is to be performed corresponds to a vertical edge boundary or a horizontal edge boundary, in operation 1401.

When the edge boundary on which deblocking filtering is to be performed corresponds to the vertical edge boundary, the PU boundary condition determining unit 1360 may determine whether PU division information of a block positioned on a right side of a left vertical edge boundary of each 8×8 block corresponds to one of an N×2N division mode and an N×N division mode, in operation 1402.

When the PU division information corresponds to one of the N×2N division mode and the N×N division mode as a result of operation 1402, the PU boundary condition determining unit 1360 may output a PU depth value of 1, in operation 1404. Otherwise, the PU boundary condition determining unit 1360 may output a PU depth value of 0, in operation 1405.

When the edge boundary on which deblocking filtering is to be performed corresponds to the vertical edge boundary, the PU boundary condition determining unit 1360 may compute accumulated depth information by adding CU depth information and a PU depth. Here, the CU depth information may be extracted, by a CU depth information extracting unit, with respect to the block positioned on the right side of the left vertical edge boundary of each 8×8 block. The PU depth may be computed by a PU division information extracting unit.

The PU boundary condition determining unit 1360 may compute a size of a PU block, that is, PU size, based on a size of an input LCU, that is, LCU size, and the computed accumulated depth information, in operation 1406. When the deblocking filtering is to be performed on the vertical edge boundary, the PU boundary condition determining unit 1360 may determine whether a resulting value obtained by performing a modulo operation of ‘OffsetX mod PU size’ corresponds to a value of 0, in operation 1407. Here, OffsetX denotes an X-axial offset extracted by a pixel offset extracting unit, and PU size denotes a size of a PU block.

When the resulting value corresponds to a value of 0, the PU boundary condition determining unit 1360 may determine a left vertical edge boundary of a corresponding 8×8 block to be a PU boundary, in operation 1408. Otherwise, the PU boundary condition determining unit 1360 may determine the left vertical edge boundary of the corresponding 8×8 block to not be the PU boundary, in operation 1409.

The modulo operation of the determining process may be replaced with an “& bit operation.”

When the edge boundary on which deblocking filtering to be performed corresponds to the horizontal edge boundary as a result of operation 1401, the PU boundary condition determining unit 1360 may determine whether PU division information of a block positioned on a lower portion of an upper horizontal edge boundary of each 8×8 block corresponds to one of an 2N×N division mode and an N×N division mode, in operation 1403.

When the PU division information corresponds to one of the 2N×N division mode and the N×N division mode, the PU boundary condition determining unit 1360 may output a PU depth value of 1, in operation 1404. Otherwise, the PU boundary condition determining unit 1360 may output a PU depth value of 0, in operation 1405.

When the edge boundary on which deblocking filtering is to be performed corresponds to the horizontal edge boundary, the PU boundary condition determining unit 1360 may compute accumulated depth information by adding CU depth information and a PU depth. Here, the CU depth information may be extracted, by the CU depth information extracting unit, with respect to the block positioned on the lower portion of the upper horizontal edge boundary of each 8×8 block. The PU depth may be computed by the PU division information extracting unit.

The PU boundary condition determining unit 1360 may compute a size of a PU block, that is, a PU size, based on a size of an input LCU, that is, LCU size, and the computed accumulated depth information, in operation 1406.

When the deblocking filtering is to be performed on the horizontal edge boundary, the PU boundary condition determining unit 1360 may determine whether a resulting value obtained by performing a modulo operation of ‘OffsetY mod PU size’ corresponds to a value of 0, in operation 1407. Here, OffsetY denotes a Y-axial offset extracted by the pixel offset extracting unit, and PU size denotes a size of a PU block.

When the resulting value corresponds to a value of 0, the PU boundary condition determining unit 1360 may determine an upper horizontal edge boundary of a corresponding 8×8 block to be a PU boundary, in operation 1408. Otherwise, the PU boundary condition determining unit 1360 may determine the upper horizontal edge boundary of the corresponding 8×8 block to not be the PU boundary, in operation 1409.

The deblocking filtering method based on raster scanning according to the above-described embodiments may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like.

Examples of program instructions include both machine code, such as produced by a compiler, and files containing higher level code that may be executed by the computer using an interpreter. The described hardware devices may be configured to act as one or more software modules in order to perform the operations of the above-described embodiments, or vice versa.

Any one or more of the software modules described herein may be executed by a controller such as a dedicated processor unique to that unit or by a processor common to one or more of the modules. The described methods may be executed on a general purpose computer or processor or may be executed on a particular machine such as the deblocking filtering apparatus described herein.

According to example embodiment, it is possible to change a conventional recursive structure to a progressive structure by sequentially performing deblocking filtering based on raster scanning in 8×8 block units in an LCU. Executions in such a sequential structure may have an advantage of the ease of hardware realization and high speed of software.

Although embodiments have been shown and described, it would be appreciated by those skilled in the art that changes may be made in these embodiments without departing from the principles and spirit of the disclosure, the scope of which is defined by the claims and their equivalents.

What is claimed is:

1. A deblocking filtering apparatus based on raster scanning, the apparatus comprising:
a boundary determining unit to determine whether at least one of a vertical edge boundary and a horizontal edge boundary of a block corresponds to at least one of a coding unit (CU) boundary, a transform unit (TU) boundary, and a prediction unit (PU) boundary;
a boundary strength (BS) computing unit to compute a BS value for at least one of the vertical edge boundary and the horizontal edge boundary when at least one of the vertical edge boundary and the horizontal edge boundary of the block corresponds to at least one of the CU boundary, the TU boundary, and the PU boundary as a result of the determining; and
a filtering performing unit to perform deblocking filtering on at least one of the vertical edge boundary and the horizontal edge boundary, based on the computed BS value.

2. The apparatus of claim 1, wherein the filtering performing unit performs deblocking filtering on the vertical edge boundary of the block, and performs deblocking filtering on the horizontal edge boundary of the block upon completion of the deblocking filtering on the vertical edge boundary of the block.

3. The apparatus of claim 1, wherein the boundary determining unit comprises:
a CU boundary determining unit to determine whether the vertical edge boundary of the block is positioned at the CU boundary, based on CU depth information of a block positioned on a right side of the vertical edge boundary of the block;
a TU boundary determining unit to determine whether the vertical edge boundary of the block is positioned at the TU boundary, based on the CU depth information and TU depth information of the block positioned on the right side of the vertical edge boundary of the block; and
a PU boundary determining unit to determine whether the vertical edge boundary of the block is positioned at the PU boundary, based on the CU depth information and PU division information of the block positioned on the right side of the vertical edge boundary of the block.

4. The apparatus of claim 3, wherein the CU boundary determining unit determines whether the horizontal edge boundary of the block is positioned at the CU boundary, based on CU depth information of a block positioned below the horizontal edge boundary of the block.

5. The apparatus of claim 3, wherein the TU boundary determining unit determines whether the horizontal edge boundary of the block is positioned at the TU boundary, based on the CU depth information and TU depth information of the block positioned below the horizontal edge boundary of the block.

6. The apparatus of claim 3, wherein the PU boundary determining unit determines whether the horizontal edge boundary of the block is positioned at the PU boundary, based on the CU depth information and PU division information of the block positioned below the horizontal edge boundary of the block.

7. The apparatus of claim 4, wherein the CU boundary determining unit comprises:
a CU depth information extracting unit to extract first CU depth information of a block positioned on a right side of a left vertical edge boundary of the block, and to extract second CU depth information of a block positioned on a lower portion of an upper horizontal edge boundary of the block;
a largest coding unit (LCU) size extracting unit to extract a size of a first LCU comprising the block positioned on the right side of the left vertical edge boundary of the block, and to extract a size of a second LCU comprising the block positioned on the lower portion of the upper horizontal edge boundary of the block;
a pixel offset extracting unit to extract an X-axial offset within the first LCU with respect to the left vertical edge boundary of the block, and to extract a Y-axial offset within the second LCU with respect to the upper horizontal edge boundary of the block; and
a CU boundary condition determining unit to determine whether the left vertical edge boundary of the block is positioned at the CU boundary, based on the first CU depth information, the size of the first LCU, and the X-axial offset, and to determine whether the upper horizontal edge boundary of the block is positioned at the CU boundary, based on the second CU depth information, the size of the second LCU, and the Y-axial offset.

8. The apparatus of claim 5, wherein the TU boundary determining unit comprises:
a TU depth information extracting unit to extract first TU depth information of a block positioned on a right side of a left vertical edge boundary of the block;
a CU depth information extracting unit to extract first CU depth information of the block positioned on the right side of the left vertical edge boundary of the block;
an LCU size extracting unit to extract a size of a first LCU comprising the block positioned on the right side of the left vertical edge boundary of the block;
a pixel offset extracting unit to extract an X-axial offset within the first LCU with respect to the left vertical edge boundary of the block;
an accumulated depth information computing unit to compute first accumulated depth information by adding the first TU depth information and the first CU depth information; and
a TU boundary condition determining unit to determine whether the left vertical edge boundary is positioned at the TU boundary, based on the size of the first LCU, the X-axial offset, and the first accumulated depth information.

9. The apparatus of claim 8, wherein
the TU depth information extracting unit extracts second TU depth information of a block positioned on a lower portion of an upper horizontal edge boundary of the block,
the CU depth information extracting unit extracts second CU depth information of the block positioned the lower portion of the upper horizontal edge boundary of the block,
the LCU size extracting unit extracts a size of a second LCU comprising the block positioned on the lower portion of the upper horizontal edge boundary of the block,
the pixel offset extracting unit extracts a Y-axial offset within the second LCU with respect to the upper horizontal edge boundary of the block,
the accumulated depth information computing unit computes second accumulated depth information by adding the second TU depth information and the second CU depth information, and
the TU boundary condition determining unit determines whether the upper horizontal edge boundary is positioned at the TU boundary, based on the size of the second LCU, the Y-axial offset, and the second accumulated depth information.

10. The apparatus of claim 6, wherein the PU boundary determining unit comprises:
a PU division information extracting unit to extract first PU division information of a block positioned on a right side of a left vertical edge boundary of the block;
a CU depth information extracting unit to extract first CU depth information of the block positioned on the right side of the left vertical edge boundary of the block;
an LCU size extracting unit to extract a size of a first LCU comprising the block positioned on the right side of the left vertical edge boundary of the block;
a pixel offset extracting unit to extract an X-axial offset within the first LCU with respect to the left vertical edge boundary of the block;
an accumulated depth information computing unit to compute first accumulated depth information by adding the first PU division information and the first CU depth information; and
a PU boundary condition determining unit to determine whether the left vertical edge boundary of the block is positioned at the PU boundary, based on the first accumulated depth information, the size of the first LCU, and the X-axial offset.

11. The apparatus of claim 10, wherein
the PU division information extracting unit extracts second PU division information of a block positioned on a lower portion of an upper horizontal edge boundary of the block,
the CU depth information extracting unit extracts second CU depth information of the block positioned on the lower portion of the upper horizontal edge boundary of the block,
the LCU size extracting unit extracts a size of a second LCU comprising the block positioned on the lower portion of the upper horizontal edge boundary of the block,
the pixel offset extracting unit extracts a Y-axial offset within the second LCU with respect to the upper horizontal edge boundary of the block,
the accumulated depth information computing unit computes second accumulated depth information by adding the second PU division information and the second CU depth information, and
the PU boundary condition determining unit determines whether the upper horizontal edge boundary of the block is positioned at the PU boundary, based on the second accumulated depth information, the size of the second LCU, and the Y-axial offset.

12. A deblocking filtering method based on raster scanning, the method comprising:
determining whether at least one of a vertical edge boundary and a horizontal edge boundary of a block corresponds to at least one of a coding unit (CU) boundary, a transform unit (TU) boundary, and a prediction unit (PU) boundary;
computing, by way of a processor, a boundary strength (BS) value for at least one of the vertical edge boundary and the horizontal edge boundary when at least one of the vertical edge boundary and the horizontal edge boundary of the block corresponds to at least one of the CU boundary, the TU boundary, and the PU boundary as a result of the determining; and
performing deblocking filtering on at least one of the vertical edge boundary and the horizontal edge boundary, based on the computed BS value.

13. The method of claim 12, wherein the performing of the deblocking filtering comprises:
performing deblocking filtering on the vertical edge boundary of the block; and
performing deblocking filtering on the horizontal edge boundary of the block upon completion of the deblocking filtering on the vertical edge boundary of the block.

14. The method of claim 12, wherein the determining comprises:
determining whether at least one of the vertical edge boundary and the horizontal edge boundary of the block is positioned at the CU boundary, based on the vertical edge boundary and the horizontal edge boundary of the block, and CU depth information of a block adjacent to the block;
determining whether at least one of the vertical edge boundary and the horizontal edge boundary of the block is positioned at the TU boundary, based on the vertical edge boundary and the horizontal edge boundary of the block, and the CU depth information and TU depth information of the block adjacent to the block; and
determining whether at least one of the vertical edge boundary and the horizontal edge boundary of the block is positioned at the PU boundary, based on the vertical edge boundary and the horizontal edge boundary of the block, and the CU depth information and PU division information of the block adjacent to the block.

15. A non-transitory computer-readable medium comprising a program for instructing a computer to perform the method of claim 12.

16. A deblocking filtering method based on raster scanning, the method comprising:
determining whether a boundary of a block corresponds to at least one of a coding unit (CU) boundary, a transform unit (TU) boundary, and a prediction unit (PU) boundary;
computing, by way of a processor, a boundary strength (BS) value for the boundary of the block when the boundary of the block corresponds to at least one of the CU boundary, the TU boundary, and the PU boundary as a result of the determining; and
performing deblocking filtering on an edge of the block based on the computed BS value.

17. The method of claim 16, wherein the boundary of the block comprises at least one of a vertical edge boundary of the block and a horizontal edge boundary of the block.

18. The method of claim 16, wherein, when the boundary of the block does not correspond to any of the CU boundary, the TU boundary, and the PU boundary, the process of computing the BS value and the process of performing the deblocking filtering are not performed.

19. A non-transitory computer-readable medium comprising a program for instructing a computer to perform the method of claim 16.
